(19) United States
(12) Patent Application Publication
(10) Pub. No.: US 2026/0273390 A1
(43) Pub. Date: Sep. 17, 2026

(54) Tracking System for Effecting Events in a Computing Environment

(71) Applicant: Refract Technologies PTE LTD, Singapore (SG)

(72) Inventor: Yu Yang Chng, Singapore (SG)

(21) Appl. No.: 19/162,515

(22) PCT Filed: Mar. 8, 2024
(86) PCT No.: PCT/SG2024/050140

§ 371 Date: Sep. 5, 2025

(30) Foreign Application Priority Data
Mar. 8, 2023 (SG) 10202300622V

(51) Int. Cl. A63F 13/214; A63F 13/218; A63F 13/428

(52) U.S. Cl. CPC A63F 13/214; A63F 13/218; A63F 13/428

(57) ABSTRACT

Provided is a tracking system for effecting events in a computing environment. The system includes an array of sensors including one or more trigger zones, each configured to execute an assigned event in the computing environment when activated; and a priming zone configured as a precursor requiring activation for the one or more trigger zones to work; and at least one processor configured to process a signal output from the array of sensors to determine a sequence in which the priming zone and the one or more trigger zones are activated; and transmit a command to execute the assigned event of the activated one or more trigger zones in response to the sequence being correct.

### CROSS-REFERENCE TO RELATED APPLICATIONS

This application is the United States national phase of International Patent Application No. PCT/SG2024/050140 filed Mar. 8, 2024, and claims priority to Singapore Patent Application No. 10202300622V filed Mar. 8, 2023, the disclosures of which are hereby incorporated by reference in their entireties.

### BACKGROUND OF THE INVENTION

### Field of the Invention

The present disclosure relates to a tracking system that allows a user to execute events in a computing environment.

### Description of Related Art

Virtual reality (VR) locomotion refers to technology that enables movement from one place to another (locomotion) within a virtual reality environment. There are several factors a user considers when choosing an interface to control locomotion of their avatar. These include:
the ability to traverse unlimited virtual worlds, even with limited physical space.
safe and intuitive to use
compact, with a form factor that is not over engineered
portable and easy to set up.

Present offerings include
thumbstick controls
devices that involve arm-swinging
omnidirectional treadmills or slidemills
shoes
sensors that detect users running on the spot.

One or more of these offerings suffer from one or more of the following shortcomings:
unnatural, unintuitive controls
causing or exacerbating VR motion sickness
unsafe
expensive, due to being overengineered
obtrusive form factor that takes up significant space
requires extensive setup and maintenance

An object of the present invention is to provide a solution that addresses the above shortcomings, while not being restricted to a locomotion application.

### SUMMARY OF THE INVENTION

According to a first aspect of the present invention, there is provided a tracking system for effecting events in a computing environment, the system comprising an array of sensors comprising one or more trigger zones, each configured to execute an assigned event in the computing environment when activated; and a priming zone configured as a precursor requiring activation for the one or more trigger zones to work; and at least one processor configured to process a signal output from the array of sensors to determine a sequence in which the priming zone and the one or more trigger zones are activated; and
transmit a command to execute the assigned event of the activated one or more trigger zones in response to the sequence being correct.

According to a second aspect of the present invention, there is provided a method of effecting events in a computing environment, the method comprising defining a physical boundary for one or more virtual trigger zones, each assigned an event to be executed in the computing environment when activated; defining a separate physical boundary for a virtual priming zone to act as a precursor requiring activation for the one or more virtual trigger zones to work; process a signal output containing a sequence in which the virtual priming zone and the one or more virtual trigger zones are activated; and
transmit a command to execute the assigned event of the activated one or more virtual trigger zones in response to determining the sequence being correct.

### BRIEF DESCRIPTION OF THE DRAWINGS

Representative embodiments of the present invention are herein described, by way of example only, with reference to the accompanying drawings, wherein:

FIG. 1 shows a top view of a pad that integrates sensors used by a tracking system in accordance with one implementation of the present invention.

FIG. 2 shows a flowchart for the operation of one or more trigger zones and a priming zone of the pad of FIG. 1 when adapted for VR locomotion tracking.

FIG. 3 shows a flowchart where a 2-step sequence used in the flowchart of FIG. 2 is reversed.

FIG. 4 shows two possible examples of a body mounted device, a head mounted display (HMD) and a hip mounted inertial measurement unit that can be used in conjunction with the pad of FIG. 1 to control avatar locomotion.

FIGS. 5 and 6 show flowcharts for possible locomotion scenarios.

FIG. 7 shows a flowchart to realise a virtual implementation of the pad of FIG. 1.

### DESCRIPTION OF THE INVENTION

In the following description, various embodiments are described with reference to the drawings, where like reference characters generally refer to the same parts throughout the different views.

Disclosed is a tracking system that is used to effect events in a computing environment, i.e. to bring about execution of commands that lead to an action, a task or a process being processed in the computer. In a preferred implementation, the tracking system is used for virtual reality, augmented reality or other forms of visual, immersive computer simulated applications. Virtual reality or VR refers to a computer simulated environment that can be interacted with by the user using hardware that can map or simulate the user's motion into the computer simulated environment. Augmented reality or AR refers to superimposition of virtual images on a real-world environment, or otherwise combining them through using a head mounted device (HMD) that allows the user to still see the real world. In another implementation, the tracking system provides a peripheral input device, similar to a mouse or a keyboard, that allows cursor control and selection of icons in a graphical user interface running in the computing environment. In yet another implementation, the tracking system serves as gaming hardware to facilitate gameplay in the computing environment.

The tracking system of the present application comprises an array of sensors which may, for example, be integrated into a mat. The pad may have any suitable shape, including a triangle, a square, a rectangle, a circle, an ellipse, a regular or irregular polygon and may be rigid, elastomeric, rollable or foldable. The pad may be formed from any suitable material or combination of materials, including foam, rubber, plastic, fabric or carpet.

The array of sensors may be one or more of capacitive, resistive, or electromagnetic sensors spatially distributed (either uniformly or non-uniformly) across the pad to detect pressure or contact applied to a surface of the mat, whereby pressure or contact detected by them notifies the computing environment that they have been activated. The array of sensors include one or more trigger zones and a priming zone, which may be realised by programming or designating some of the pad sensors as the one or more trigger zones and other pad sensors as the priming zone.

The priming zone refers to sensors that when activated notifies the computing environment to expect a command to execute an event in the computing environment. Examples of executable events include, but are not limited to, selection of an object in the computing environment, entering a command into a game running in the computing environment, and controlling locomotion of an avatar in the computing environment. In general, activation of the priming zone does not lead to any event execution but is required for the one or more trigger zones to work and cause event execution. That is event execution is due to activation of another zone. The command to execute an event is from activation of the one or more trigger zones, while the event that occurs (i.e. what action, task or process happens next in the computing environment) depends on which of the one or more trigger zones is activated. The priming zone is thus configured to serve as a precursor requiring activation for the one or more trigger zones to work. The one or more trigger zones and the priming zone are activated when pressure or contact is detected by their respective sensors.

In use, each trigger zone or plurality of trigger zones is pre-programmed to provide input which is expected from their adopted application (for example, if the tracking system is used for VR locomotion, each trigger zone or plurality of trigger zones is used to set a travel direction for an avatar; while if the tracking system is used for a music, dance and rhythm game, each trigger zone or plurality of trigger zones is used to capture input response to musical and visual cues). Such pre-programming results in an event being assigned to these trigger zones. When the trigger zone or plurality of trigger zones are activated, instructions are sent to the computing environment to execute their assigned event. One or more trigger zones may be assigned to the same event, to accommodate for proximity of sensor placement over the mat. For example, if sensors are spread out so that the probability of having adjacent trigger zones being simultaneously activated at any instance is low, then the sensors for each of such adjacent trigger zones may be assigned different events. On the other hand, if the sensors are densely packed so that it is likely that at any instance adjacent trigger zones are simultaneously activated, then a plurality of trigger zones may be assigned the same event.

The tracking system of the present application also comprises at least one processor that is in communication with the array of sensors. The term “processor” may refer an application specific integrated circuit (ASIC), central processing unit (CPU), graphics processing unit (GPU), programmable logic device (PLD), microcontroller, field programmable gate array (FPGA), microprocessor, digital signal processor (DSP), or other suitable component. The processor can be configured using machine readable instructions stored on a memory. The processor may be centralised or distributed, such as integrated with the array of sensors or housed separately, such as located at the computing environment.

The processor is configured to process a signal output from the array of sensors to determine a sequence in which the priming zone and the one or more trigger zones are activated. The sequence refers to an order in which the priming zone and the one or more trigger zones are activated. The processor transmits a command to execute the assigned event of the activated one or more trigger zones in response to the sequence being correct. That is, if the sequence is determined correct, the processor transmits a command to execute the event, due to the activated one or more trigger zones, in the computing environment. If the processor detects that the activated one or more trigger zones result in more than one event being executed, the processor may transmit a command that combines these events for execution in the computing environment. For example, if a trigger zone that causes avatar forward movement and a trigger zone that causes avatar sideway movement are both activated, the processor may transmit a command that causes the avatar to move in a diagonal direction in the computing environment.

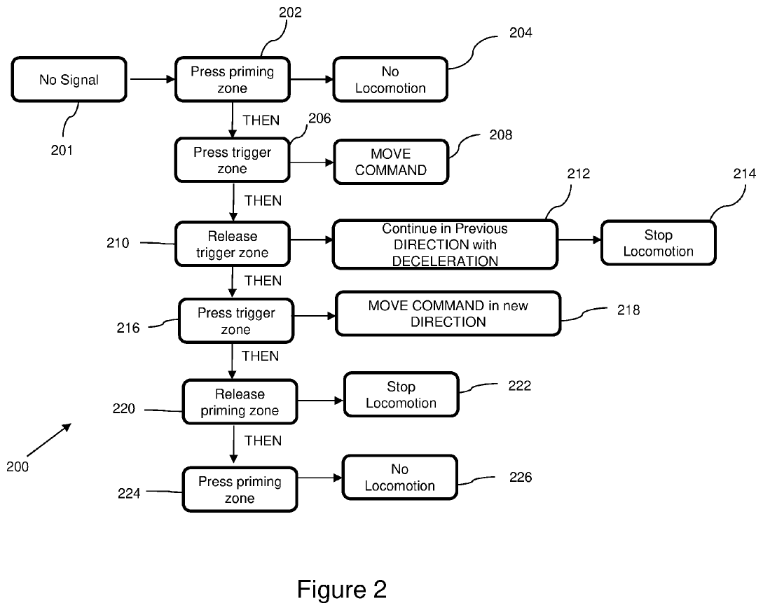

In general, the command to execute the assigned event of the one or more trigger zones is transmitted provided these one or more trigger zones are activated while the priming zone is activated. In addition, the correct sequence requires, in general, the priming zone being activated before the one or more trigger zones, with the priming zone remaining activated while the one or more trigger zones are activated. This correct sequence is described in more detail below against the various operation scenarios of FIGS. 2, 5 and 6.

The processor is also further configured to disregard activation of either the one or more trigger zones, the priming zone or both if performed in an incorrect sequence. For example, if the processor detects that the priming zone is not activated (or deactivated), the processor remains passive when detecting that one or more trigger zones are activated. Similarly, if the processor detects that the priming zone is activated, but the one or more trigger zones are not activated (or deactivated), no action will be taken. If the processor detects that the one or more trigger zones are activated first, followed by activation of the priming zone while the priming zone remains activated, this will also not result in execution of the events due to the activated one or more trigger zones.

Operation of the either the one or more trigger zones, the priming zone or both in the incorrect sequence has the effect of any of these zones being considered dormant, and results in no command being sent to the computing environment and a non-reaction in the computing environment.

By imposing a requirement that the priming zone and the one or more trigger zones be activated in a correct sequence for an event to be executed in the computing environment, this ensures that a command executed by the tracking system is the result of a conscious user decision. The tracking system being further configured to disregard activation of its sensors when performed in an incorrect sequence further reinforces adherence to the correct sequence as it prevents the computing environment from reacting to their accidental activation. This is advantageous in a gaming application as it provides an option for the user to walk on the pad without eliciting a change in their avatar status.

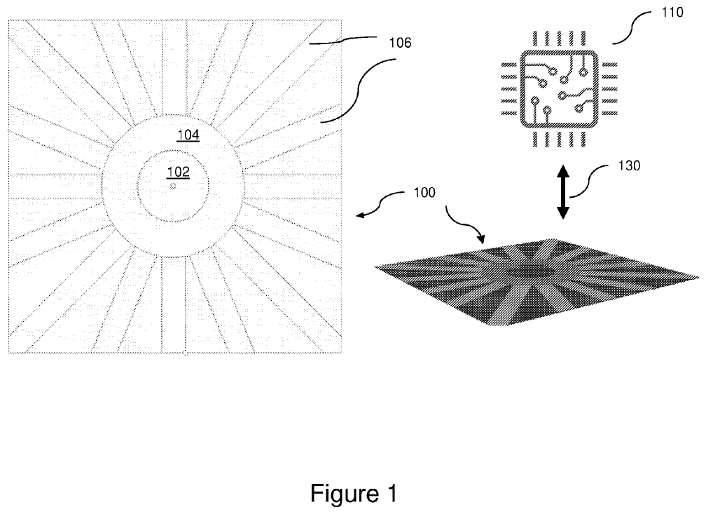

The operation of the tracking system is described in greater detail below in conjunction with FIGS. 1 to 7, which is directed at a virtual reality application. However, as mentioned above, the tracking system can also be used as a peripheral input device that is in addition to or as a replacement to a mouse and keyboard; and may also be use for other applications such as footwork tracking for music, dance and rhythm games; aerobics fitness; force transference and weight distribution analytics; and training for sports like golf, baseball and tennis. As such, the discussion below with reference to FIGS. 1 to 7, is representative of only one possible application for the tracking system.

FIG. 1 shows a top view and a perspective view of a pad 100 that integrates sensors used by the tracking system of the present invention. As mentioned above, the pad 100 may have any suitable shape, including a triangle, a square, a rectangle, a circle, an ellipse, a regular or irregular polygon and may be rigid, elastomeric, rollable or foldable. In one implementation, the pad 100 is a special-purpose floor pad specifically configured for use with a virtual reality system. The pad 100 may also include haptic feedback devices for physical interaction with a user.

The pad 100 has an array of sensors having a priming zone 102; one or more trigger zones 106; and a neutral zone 104. The primary zone 102, the trigger zones 106 and the neutral zone 104 are independently activatable zones. The array of sensors may be one or more of capacitive, resistive, or electromagnetic sensors that can detect pressure or contact. The sensors are spatially distributed, where the implementation of FIG. 1 has the priming zone 102 located in the centre and surrounded by the one or more trigger zones 106, with the neutral zone 104 located in between the priming zone 102 and the one or more trigger zones 106. The three different zones 102, 104, 106 are segregated by differing materials, textures, patterns and/or grooves (MTPG) to provide tactile feedback, which allows each of them to be discernible by the foot. In one implementation, the grooves are achieved by having one or more of the trigger zones 106, the neutral zone 104; and the priming zone 102 having different heights. A possible layout for the pad 100 is as follows:

### Priming Zone 102

Located at the center of the pad 100, the portion of the pad 100 where the sensors for the priming zone 102 are located is shaped in a circle between 20 to 30 cm diameter. It is a raised area of height around 12 mm, with smooth, rounded edges. In one embodiment, the portion of the pad 100 for the priming zone 102 has a different MTPG from the trigger zones 106.

### Trigger Zones 106

The trigger zones 106 are located in a deck area of the pad 100 outside of the priming zone 102 and the neutral zone 104. In one embodiment, the portion of the pad 100 having the sensors for the trigger zones 106 is raised slightly higher than the portion of the pad 100 having the sensors for the neutral zone 104 and is lower or equal in height to the portion of the pad 100 having the sensors for the priming zone 102. The deck has a different MTPG from the priming zone 102 and the neutral zone 104.

### Neutral Zone 104

Situated between the priming zone 102 and the trigger zones 106, the portion of the pad 100 having the sensors for the neutral zone 104 has a slightly sunken ring-shaped area, between 40 to 70 cm in diameter. The height of this portion of the pad 100 may be between 6 mm to 9 mm. In one embodiment, the portion of the pad 100 for the neutral zone 104 has the same MTPG as the portion of the pad 100 for the priming zone 102, but not the portion of the pad 100 with the trigger zones 106.

To have the pad 100 work in its adopted application, each of the trigger zones 106 or a plurality of the trigger zones 106 is configured (through pre-programmed instructions) to perform an action, task or process, specific to the adopted application, when activated. The pre-programming of an action, task or process results in an event being assigned to the each of the trigger zones 106 or a plurality of them, with the event being executed in the computing environment when these trigger zones 106 are activated. However, the trigger zones 106 are configured to work in tandem with the priming zone 102, since the priming zone 102 is configured to be a precursor requiring activation for the one or more trigger zones 106 to work. That is, the priming zone 102 needs to be activated before the one or more trigger zones 106 can work (i.e. the trigger zones 106 only work after the priming zone 102 is activated). The sensors for the neutral zone 104 are not assigned any event and serve to provide a rest area to initiate a new event or change between events. Whether the one or more trigger zones 106 and the priming zone 102 are being operated correctly is determined by one or more processors 110 with which the array of sensors are in communication (represented by bidirectional arrow 130). The at least one processor 110 is configured to process a signal output from the array of sensors to determine a sequence in which the priming zone 102 and the one or more trigger zones 106 are activated. The processor 110 is in turn in communication with a computing environment to which it will transmit a command to execute the assigned event of the activated one or more trigger zones 106 in response to the sequence being correct. The processor 110 is also further configured to disregard activation of either the one or more trigger zones, the priming zone or both if performed in an incorrect sequence, which results in no command being sent to the computing environment and a non-reaction in the computing environment. For example, the processor 110 is configured to only act on signals from the one or more trigger zones 106 after the priming zone 102 is first activated and remains activated when the one or more trigger zones 106 are activated.

The operation of the one or more trigger zones 106 and the priming zone 102 when adapted for VR locomotion tracking is described with reference to the flowchart 200 of FIG. 2. VR locomotion refers to the technology that enables movement of a user's avatar through a virtual world created in the computing environment, using only a small real-world space, with the tracking system of the present invention being advantageous for allowing room scaling. For such an application, each of the trigger zones 106 is assigned an event that relates to controlling locomotion of an avatar in the computing environment, such as a direction of the locomotion.

The tracking system enables intuitive VR locomotion by triggering a directional move command when a user follows a 2-step sequence of the priming zone 102 being activated first, followed by activation of the one or more trigger zones 106. Any reference to a stepping motion to activate the one or more trigger zones 106 and the priming zone 102 is in the context of a pad incorporating being placed on the floor and used as a mat. However, the pad may also be placed on a table, whereby a user's hand then activates the one or more trigger zones 106 and the priming zone 102.

The flowchart 200 begins 201 with the processor 110 detecting a status of the computing environment. The first step of the 2-step sequence occurs at stage 202 where a user steps on the priming zone 102 with one foot since the priming zone 102 acts as a precursor requiring activation for the one or more trigger zones to work. As stated in stage 204, no locomotion in the computing environment occurs, with the computing environment being primed to receive a command to execute an event in the computing environment from the one or more trigger zones 106 being subsequently activated.

The second step of the 2-step sequence occurs in stage 206 of the flowchart 200. For the second step, the user keeps their foot on the priming zone 102 and steps on the one or more trigger zones 106 with his other foot. The event that is assigned to the activated one or more trigger zones 106 is executed, with the computing environment receiving a move command in stage 208, which brings about a desired locomotion in the avatar. This 2-step sequence of stage 202 and 206 applies to strafing and backwards movement as well as forward movement.

The operation of stages 201, 202 and 206 thus illustrate that in the absence of an ongoing event relating to avatar locomotion in the computing environment from previous activation of one or more of the trigger zones 106 (from the processor 110 not transmitting a command to the computing environment in stage 201), the correct sequence to have the processor 110 transmit a command to execute an avatar locomotion event assigned to a trigger zone 106 has the priming zone 102 being activated before the activation of the trigger zone 106.

Stage 210 occurs should a user wish to change or adjust their direction of movement. The user lifts their foot from the one or more trigger zones 106 while maintaining their other foot on the priming zone 102. Stage 212 then occurs where the avatar in the computing environment will continue with the previous move command at a time delay/decay (e.g. 0.5 to 2 seconds or any other pre-programmed interval), which is perceived as the avatar decelerating or undergoing a gliding motion. Should the user not step on a trigger zone, stage 214 occurs where locomotion eventually stops.

Following stage 210 where the user maintains one foot on the priming zone 102, stage 216 occurs when the user places the other foot onto another trigger zone 106. When the user places their foot on this other trigger zone 106 within the glide window, the avatar adjusts to the new direction in stage 218 without losing speed or at most a slight deceleration. Alternatively, if the other trigger zone 106 is activated after locomotion has stopped, the avatar will then move in the new direction in a similar manner as that described with respect to the stage 208.

The operation of stages 210, 216 and 218 illustrate that the processor 110 compares whether an assigned event of a currently activated trigger zone 106 (the locomotion direction set in stage 218) is new against an ongoing event in the computing environment from previous activation of the trigger zone 106 (the locomotion direction set in stage 206). The correct sequence to execute the new assigned event comprises the priming zone remaining activated during the activation of the current trigger zone 106.

Stage 220 relates to the processor 110 being configured to terminate an ongoing event (being the direction of locomotion set as described in stage 218) in the computing environment from previous activation of one or more of the trigger zones 106 in response to detection of deactivation of the priming zone 102. Thus, to quickly stop their avatar. the user simply lifts their foot from the priming zone 102 during any point of operation. The avatar comes to a stop in stage 222.

Following stage 222, placing their foot anywhere on the pad 100 will not trigger a move command unless the user re-engages the 2-step sequence of stage 202, followed by stage 206. That is the processor 110 determines a sequence in which the priming zone 102 and one or more of the trigger zones 106 are activated; and transmits a command to execute the assigned event of the activated one or more trigger zones 106 in response to the sequence being correct. Thus, if the user only steps the priming zone 102 without subsequently stepping on a trigger zone 106 in stage 224, stage 226 occurs where no locomotion is executed in the computing environment.

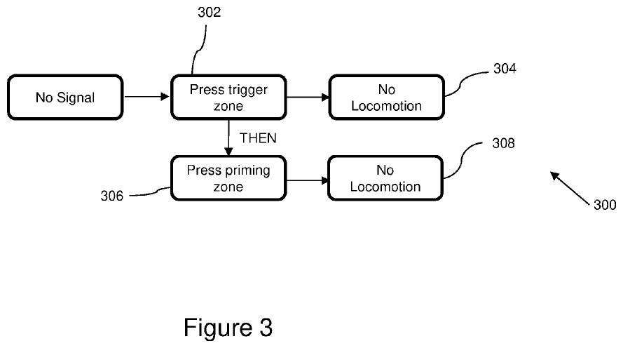

A sequence or combination of steps, other than the 2-step sequence of stage 202, followed by stage 206, will not trigger a move command. This is due to the processor 110 being configured to disregard activation of either the one or more trigger zones 106, the priming zone 102 or both if performed in an incorrect sequence, as illustrated in FIG. 3.

FIG. 3 shows a flowchart 300 where the 2-step sequence is reversed. In stage 302, a user first steps on any one of the trigger zones 106. This results in stage 304 where no locomotion occurs. In stage 306, the user next steps on the priming zone 102. This results in stage 308 where no locomotion occurs. Accordingly, when the activation sequence of the one or more trigger zones 106 and the priming zone 102 is incorrect, the processor 110 does not transmit a command to the computing environment. This means the user can move freely on the pad 100 while playing games or using applications without triggering a move command, yet is still able to execute a move command readily by returning to the 2-step sequence when required. Configuring the processor 110 to be unresponsive to activation of the priming zone 102 and the trigger zones pad 100 in an incorrect sequence allows safe play as the pad 100 becomes a reference to a user's physical surroundings, while immersed in VR with a HMD worn. The user senses that as long as they have one or both feet on the pad 110, they are safely out of range of physical objects in their use-space. The trigger zones 106 and the priming zone 102 having one or more of the following physical features: different heights; different surface textures and different surface designs results in different MTPG between the trigger zones 106 and the priming zone 102, which allow a user to instinctively/intuitively sense, without having to see the mat, their position on the pad 110 relative to the priming zone 102, their general location on the pad 110, and the location of the priming zone 102 and the trigger zones 106.

The operation described in FIGS. 2 and 3 thus show that for an event to occur, the priming zone 102 has to be activated. An event in the computing environment is effected by a trigger zone 106 being activated (if the avatar is at rest) or a change in the trigger zone 106 that is being activated (if the avatar is already in motion). Each of the trigger zones 106 may also be programmed to factor pressure applied during their activation, which impacts the way their assigned event is executed. In the scenario of FIGS. 2 and 3, where the event relates to controlling avatar locomotion, the applied pressure may control a speed at which the locomotion occurs. Lighter pressure results in the avatar walking, while greater pressure results in a run or a sprint.

In addition to being assignable to events that relate to controlling locomotion of an avatar, each of the trigger zones 106 may be assigned events that correspond to their adopted application. For instance, the assignable events include selection of an object in the computing environment; and entering a command into a game running in the computing environment. Each trigger zone 106 may also be assigned to events that relate to other applications that include:
Input replacement for WASD keyboard, joystick, and/or thumbstick configuration for FPS and third-person games
Racing games
Music, art and general creativity
Footwork tracking for music, dance, and rhythm games, as well as aerobics fitness applications
Force transference and weight distribution analytics and training for sports like golf, baseball, tennis etc
Motion capture calibration via foot placement in indoor/absolute positioning
Real time Indoor/absolute position tracking via foot placement and pose estimation
Weight distribution and centre of gravity estimation for
Tele-medicine for physiotherapy and rehabilitation.
General training and simulation in diverse industries

When the pad 100 serves as the only input device to control an avatar in the computing environment, FIGS. 2 and 3 describe an operation where each of the trigger zones 106 controls either locomotion movement, facing/orientation of the avatar, or both. For example, one foot stepping on a trigger zone 106 on the left or on the right of the priming zone 102, with the other foot remaining on the priming zone 102 causes the avatar to respectively turn to the left or to the right. Using one foot to step on a trigger zone 106 in front of or behind the priming zone 102, with the other foot remaining on the priming zone 102 causes the avatar to respectively move forward or move backward. Additional programming may also be present, such as double tapping the trigger zone 106 on the left or on the right of the priming zone 102 causes an avatar to move sideways, with the avatar still facing the front.

In another implementation, the processor 110 supports other peripheral devices, such as a body mounted device, in addition to the trigger zones 106 to control an avatar in the computing environment. The trigger zones 106 effect locomotion, while the body mounted device provides direction of the locomotion.

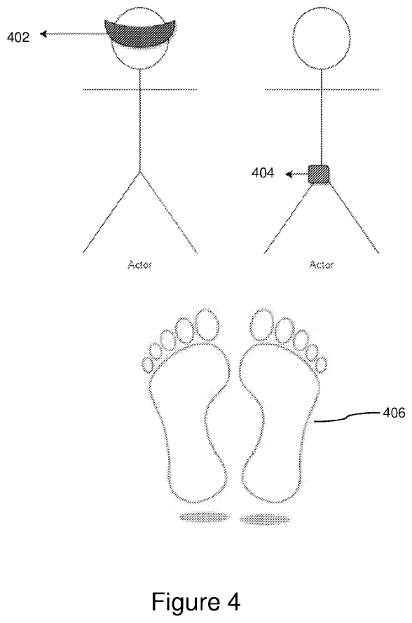

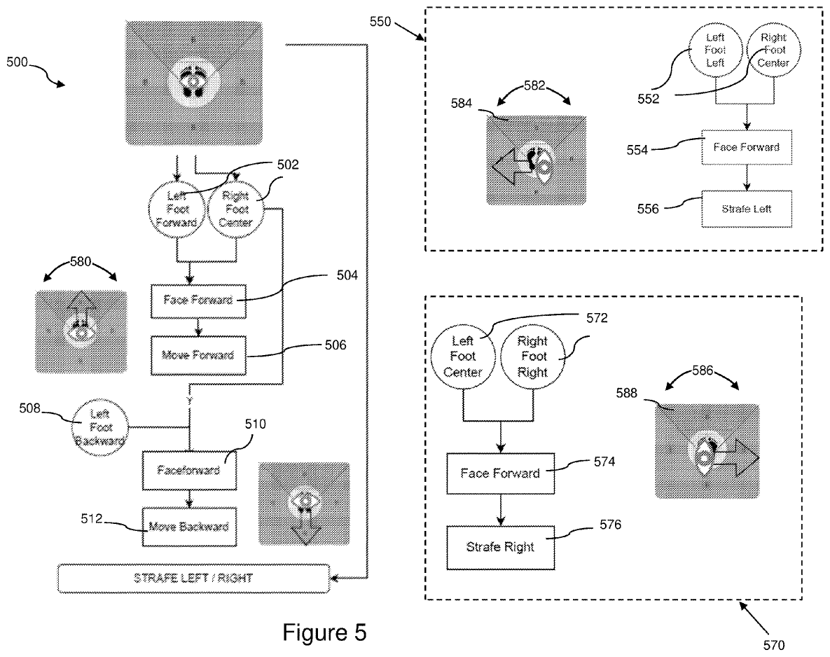

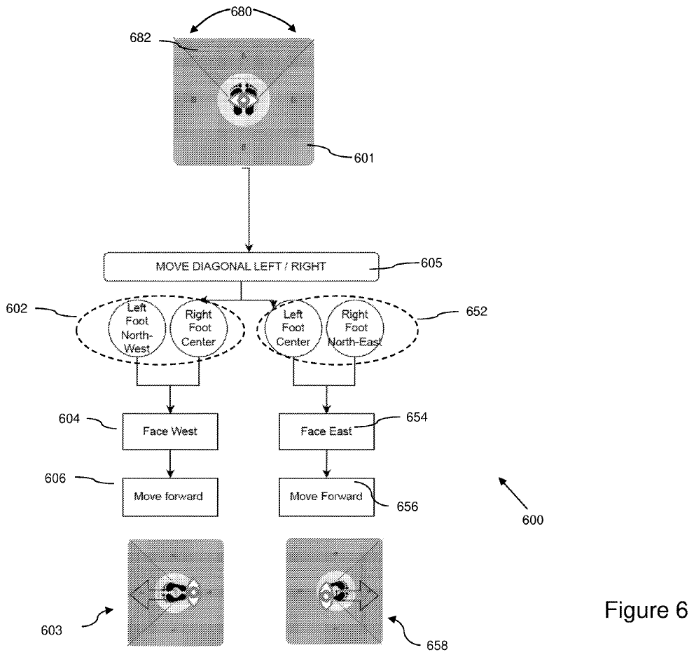

FIG. 4 shows two possible examples of a body mounted device, a head mounted display (HMD) 402 and a hip mounted inertial measurement unit (IMU) 404. The processor 110 receives input from the body mounted device 402, 404 providing an orientation of the avatar and includes the orientation of the avatar when transmitting a command instructing the computing environment of the event to execute resulting from activation of a trigger zone 106. The body mounted device 402, 404 determines the orientation of the avatar through determining the facing of the user (also interchangeably referred to as the “actor”), described in greater detail with respect to FIGS. 5 and 6.

FIGS. 5 and 6 show flowcharts 500, 550, 570 and 600 for possible locomotion scenarios, where the body mounted device 402, 404 work in tandem with feet 406 placement on the priming zone 102 and the trigger zones 106. These are sample locomotion scenarios and are thus non-exhaustive.

Flowchart 500 relates to a sequence of steps which results in the avatar moving forward or backward. In step 502, the processor 110 detects that the priming zone 102 is first activated, followed by activation of one or more trigger zones 106 forward of the priming zone 102 while the priming zone 102 remains activated. The processor 110 determines that one or more trigger zones 106 forward of the priming zone 102 are activated from the facing of the actor. In step 504, the processor 110 detects from the body mounted device 402, 404 that the actor is facing forward. The trigger zones 106 that lie within an angular region 580 forward (or in front) of the actor's facing, as determined by the body mounted device 402, 404, are considered in alignment with the actor's facing. In response to verifying that one or trigger zones 106 within the angular region 580 are activated, the processor 110 transmits a command to move the avatar forward in step 506. In step 508, the processor 110 detects that while the priming zone 102 remains activated, the one or more trigger zones 106 forward of the priming zone 102 is deactivated and replaced with activation of the one or more trigger zones 106 behind the priming zone 102. In step 510, the processor 110 detects from the body mounted device 402, 404 that the actor is still facing forward. In response, the processor 110 transmits a command to move the avatar backward in step 512.

Flowchart 550 relates to a sequence of steps which results in the avatar strafing left. A left strafe motion refers to the avatar moving in a left arc. In step 552, the processor 110 detects that the priming zone 102 is first activated, followed by activation of one or more trigger zones 106 left of the priming zone 102 while the priming zone 102 remains activated. In step 554, the processor 110 detects the actor's facing from the body mounted device 402, 404 and the trigger zones 584 within the angular region 582 that are forward of the actor's facing. The processor 110 determines that the activated trigger zones 106 to the left of the priming zone 102 fall outside of the trigger zones 584 within the forward angular region 582. The activated trigger zones 106 are considered misaligned with the actors' facing to an extent which is to execute a strafing movement. In response, the processor 110 transmits a command that makes the avatar strafe left in step 556. Flowchart 570 relates to a sequence of steps which results in the avatar strafing right. A right strafe motion refers to the avatar moving in a right arc. In step 572, the processor 110 detects that the priming zone 102 is first activated, followed by activation of one or more trigger zones 106 right of the priming zone 102 while the priming zone 102 remains activated. In step 574, the processor 110 detects the actor's facing from the body mounted device 402, 404 and the trigger zones 588 within the angular region 586 that are forward of the actor's facing. The processor 110 determines that the activated trigger zones 106 to the right of the priming zone 102 fall outside of the trigger zones 588 within the forward angular region 586. The activated trigger zones 106 are considered misaligned with the actors' facing to an extent which is to execute a strafing movement. In response, the processor 110 transmits a command that makes the avatar strafe right in step 576.

FIG. 6 describes misalignment between activated one or more trigger zones 106 and trigger zones 682 lying within an angular region 680 forward of the actor's facing, that results in diagonal movement of the avatar. The extent of misalignment for diagonal movement is less than that for strafing movement described with respect to FIG. 5.

A left diagonal or a right diagonal movement of the avatar (see step 605) occurs when the processor 110 detects activation of the priming zone 102; and activation of a trigger zone 106 that is diagonal to the facing of the actor, the actor's facing being obtained from the HMD 402 and/or the IMU 404. This left diagonal or right diagonal movement is set out respectively in steps 602 and 652 as follows, where the actor is facing north.

In step 602, the priming zone 102 and a trigger zone 106 that is diagonally left are activated, with the activated trigger zone 106 being outside of the angular region 680 forward of the actor's facing. The processor 110 senses misalignment between the actor's facing and the activated trigger zone 106 in that the actor is facing front and a diagonally left located trigger zone 106 is activated. Accordingly, the avatar moves diagonally left.

In step 652, the priming zone 102 and a trigger zone 106 that is diagonally right are activated, with the activated trigger zone 106 being outside of the angular region 680 forward of the actor's facing. The processor 110 senses misalignment between the actor's facing and the activated trigger zone 106 in that the actor is facing front and a diagonally right located trigger zone 106 is activated. Accordingly, the avatar moves diagonally right.

Steps 604 and 606 relate to avatar movement when the user's facing and feet are in a west direction, as shown in image 603. With the priming zone 102 already activated, the processor 110 detects that the activated trigger zone 106 and the user's facing, as obtained from the HMD 402 and/or the IMU 404, are in alignment. This results in the avatar moving forward. Similarly, steps 654 and 656 relate to avatar movement when the user's facing and feet are in an east direction, as shown in image 604. With the priming zone 102 already activated, the processor 110 detects that the activated trigger zone 106 and the user's facing, as obtained from the HMD 402 and/or the IMU 404, are in alignment. This results in the avatar moving forward.

A default angular separation for the angular regions 582, 584, 586 and 680 may be 30°, although the degree (i.e. how wide or narrow) may be user specified. The processor 110 may also be programmed, through user profile settings, to prioritise output from certain trigger zones 106 over other trigger zones 106 to address a scenario where trigger zones 106 assigned to different movements are simultaneously activated. For instance, if diagonal movement is set to be the primary movement, having trigger zones 106 assigned to diagonal movement and trigger zones 106 assigned to strafing movement simultaneously activated will result in the avatar moving diagonally. Similarly, if strafing movement is set to be the primary movement, having trigger zones 106 assigned to diagonal movement and trigger zones 106 assigned to strafing movement simultaneously activated will result in the avatar executing a strafing motion.

FIGS. 1 to 6 describe a physical implementation of the trigger zones 106 and the priming zone 102 using the pad 100. However, the trigger zones and the priming zone may also be virtually implemented.

In one approach, the pad 100, its priming zone 102, neutral zone 104 and trigger zones 106 may be projected onto a surface (e.g. a mat or mat portion, or directly onto a floor or other ground surface) using a source falling within the visible. infrared, near-infrared, or other suitable portion of the light spectrum. Activation of these virtual zones 102, 104 and 106 is determined through a sensor detecting which of these projected zones are occupied during use.

In another approach, the user allocates an area in the computing environment to map each of the priming zone 102, the neutral zone 104 and the trigger zones 106, based on the physical space in which a virtual pad is to be implemented. The mapping allows for the virtual zones 102, 104 and 106 to be overlaid onto their respective defined areas in physical space. The user can see the virtual zones 102, 104 and 106 of the virtual pad through their HMD (refer HMD 402 of FIG. 4). The virtual zones 102, 104 and 106 that are in activation at any instant are determined by the location of the user's feet, as detected by data transmitted from one or more IMUs placed on the lower limbs. Accordingly, the user does not need a physical mat with an array of sensors, but only needs to markout areas for the priming zone 102, the neutral zone 104 and the trigger zones 106 in physical space and a pad will be overlaid virtually in the HMD, which can be seen through their HMD. The overlay can also be determined through selection of a default templates, instead of being drawn inside the virtual space from the above mentioned mapping.

The virtual map may be deactivated when the user wishes to carry out tasks in the physical space; or if the player wishes to move to another physical space to implement the virtual map, with the other physical space having sufficient area to accommodate the already defined area needed for the virtual zones 102, 104 and 106. If the new physical space cannot accommodate, then the virtual zones 102, 104 and 106 need to be remapped.

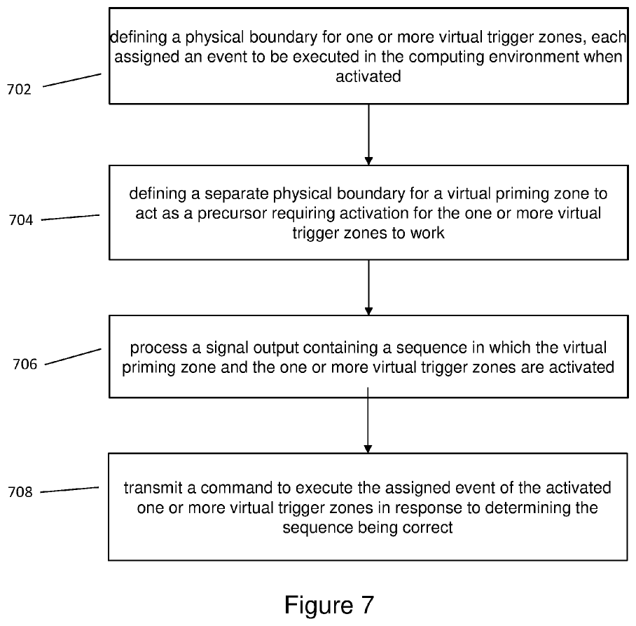

FIG. 7 shows a flowchart 700 executed by a processor, for example from the computing environment, to realise this virtual implementation. The flowchart 700 is directed at steps of a method of effecting events in a computing environment.

In step 702, a physical boundary for one or more virtual trigger zones is defined. Each virtual trigger zone is assigned an event to be executed in the computing environment when activated. The virtual tigger zone has corresponding functions as the trigger zone 106 described with reference to FIGS. 1 and 6, so is not elaborated.

In step 704, a separate physical boundary for a virtual priming zone is defined. The virtual priming zone acts as a precursor requiring activation for the one or more virtual trigger zones to work. The virtual priming zone has corresponding functions as the priming zone 102 described with reference to FIGS. 1 and 6, so is not elaborated.

In step 706, a signal output containing a sequence in which the virtual priming zone and the one or more virtual trigger zones are activated is processed. In step 708, a command to execute the assigned event of the activated one or more virtual trigger zones in response to determining the sequence being correct, is executed. The correct sequence corresponds to that described with reference to FIGS. 1 and 6 in respect of the trigger zones 106 and the priming zone 102, so is not elaborated. Activation of the one or more virtual trigger zones and the virtual priming zone comprises a sensor detecting occupation of the physical boundary and the separate physical boundary respectively.

The virtual implementation uses the same control logic as the physical implementation described above with reference to FIGS. 1 to 6. Accordingly, activation of either the one or more virtual trigger zones, the virtual priming zone, or both, if performed in an incorrect sequence, results in no command being sent to the computing environment. A command to execute the assigned event of the one or more virtual trigger zones is transmitted provided they are activated while the virtual priming zone is activated.

Similar to its physical implementation, operation of this virtual implementation involves detection of the status of the computing environment.

In one operation scenario, detection of the status of the computing environment compares whether an assigned event of a currently activated one or more of the virtual trigger zones is new against an ongoing event in the computing environment from previous activation of one or more of the virtual trigger zones. The correct sequence to execute the new assigned event requires the virtual priming zone to remain activated during the activation of the current one or more of the virtual trigger zones.

In another operation scenario, detection of the status of the computing environment verifies an absence of ongoing events in the computing environment from previous activation of one or more of the virtual trigger zones. The correct sequence to execute an event assigned to one or more virtual trigger zones requires the virtual priming zone being activated before the activation of those virtual trigger zones.

When there is an ongoing event in the computing environment from previous activation of one or more of the virtual trigger zones, this ongoing event is terminated in response to detection of deactivation of the virtual priming zone.

Each of the virtual trigger zones can be configured to perform the same events as their physical trigger zone 106 counterpart, which include any one or more of the following: selection of an object in the computing environment, entering a command into a game running in the computing environment, and controlling locomotion of an avatar in the computing environment. When used to control locomotion of an avatar, the virtual implementation may also receive input providing an orientation of the avatar from a body mounted device such as a HMD or a hip mounted IMU.

Details on the virtual implementation of FIG. 7 were described earlier, namely that since there is no use of a physical pad, a virtual space for the pad will need to be defined. This involves setting a boundary for each of the virtual priming zone, the virtual neutral zone and the virtual trigger zone within this virtual space. The virtual pad can then be overlaid over the virtual space.

With the virtual pad disabled, the range of avatar movement in the computing environment is constrained by the boundary of the user's available physical space. To allow the avatar full locomotion range unconstrained by the user's available physical space, the user activates the virtual pad and moves to the virtual priming zone, whose location is fixed. The user then activates the virtual priming zone and the virtual target zone in accordance with the 2-step sequence, which allows unrestricted locomotion across the computing environment. In addition to or as an alternative to the above mentioned use of a HMD with the virtual pad, a hip mounted inertial measurement unit (refer IMU 404 shown in FIG. 4) can also be used to determine which of the virtual zones 102, 104 and 106 are activated at any instance, along with determining the facing of a player or an initial forward (north) direction. Should the player decided to change his initial forward direction (e.g. from north to east), they have to disengage and set their new forward direction to east and perform a recenter sequence.

In the application, unless specified otherwise, the terms “comprising”, “comprise”, and grammatical variants thereof, intended to represent “open” or “inclusive” language such that they include recited elements but also permit inclusion of additional, non-explicitly recited elements.

While this invention has been described with reference to exemplary embodiments, it will be understood by those skilled in the art that various changes can be made and equivalents may be substituted for elements thereof, without departing from the scope of the invention. In addition, modification may be made to adapt the teachings of the invention to particular situations, without departing from the essential scope of the invention. Thus, the invention is not limited to the particular examples that are disclosed in this specification, but encompasses all embodiments falling within the scope of the appended claims.

1. A tracking system for effecting events in a computing environment, the system comprising
an array of sensors integrated into a pad, the array of sensors providing
one or more trigger zones, each configured to execute an assigned event in the computing environment when activated; and
a priming zone configured as a precursor requiring activation for the one or more trigger zones to work; and
at least one processor configured to
process a signal output from the array of sensors to determine a sequence in which the priming zone and the one or more trigger zones are activated; and
transmit a command to execute the assigned event of the activated one or more trigger zones in response to the sequence being correct, wherein the command to execute the assigned event of the one or more trigger zones is transmitted provided they are activated while the priming zone is activated.

2. The tracking system of claim 1, wherein the at least one processor is further configured to
disregard activation of either the one or more trigger zones, the priming zone or both if performed in an incorrect sequence, resulting in no command being sent to the computing environment.

3. The tracking system of claim 1, wherein the processor is further configured to detect a status of the computing environment.

4. The tracking system of claim 3, wherein detection of the status of the computing environment comprises the processor being further configured to
compare whether an assigned event of a currently activated one or more of the trigger zones is new against an ongoing event in the computing environment from previous activation of one or more of the trigger zones; and
wherein the correct sequence to execute the new assigned event comprises the priming zone remaining activated during the activation of the current one or more of the trigger zones.

5. The tracking system of claim 3, wherein detection of the status of the computing environment comprises the processor being further configured to
verify an absence of ongoing events in the computing environment from previous activation of one or more of the trigger zones; and
wherein the correct sequence comprises the priming zone being activated before the activation of the one or more of the trigger zones.

6. The tracking system of claim 1, wherein the processor is further configured to
terminate an ongoing event in the computing environment from previous activation of one or more of the trigger zones in response to detection of deactivation of the priming zone.

7. The tracking system of claim 1, wherein the event comprises any one or more of the following: selection of an object in the computing environment, entering a command into a game running in the computing environment, and controlling locomotion of an avatar in the computing environment.

8. The tracking system of claim 7, wherein the processor is further configured to
receive input providing an orientation of the avatar and include the orientation of the avatar into the transmitted command.

9. The tracking system of claim 8, wherein the input is received from a body mounted device.

10. The tracking system of claim 1, wherein the one or more trigger zones and the priming zone have one or more of the following physical features: different heights; different surface textures and different surface designs.

11. The tracking system of claim 1, wherein the one or more trigger zones surround the priming zone.
